(19) United States
(12) Patent Application Publication
(10) Pub. No.: US 2023/0196485 A1
(43) Pub. Date: Jun. 22, 2023

(54) AFTER-REPAIR VALUE ("ARV") ESTIMATOR FOR REAL ESTATE PROPERTIES

(71) Applicant: AVR HOLDING LLC, Laurel, MD (US)

(72) Inventor: Joseph Girsch, Laurel, MD (US)

(21) Appl. No.: 17/710,282

(22) Filed: Mar. 31, 2022

Related U.S. Application Data
(60) Provisional application No. 63/290,325, filed on Dec. 16, 2021.

(51) Int. Cl. G06Q 50/16; G06Q 30/02

(52) U.S. Cl. CPC G06Q 50/165; G06Q 30/0278; G06Q 30/0206; G06Q 30/0201

(57) ABSTRACT

A two-model method for estimating the After-Repair Value (“ARV”) of residential real estate properties, regardless of their current or advertised condition. The method employs an automated scalable process that uses realtor descriptions of thousands of properties to achieve this goal. The first model involves implementing a software machine learning classification algorithm, augmented with natural language processing (NLP) techniques, to evaluate thousands of properties and identify recent renovations for use as comparables. The second model uses the renovation outputs of the first model to estimate the ARV of every property in the system. The output of this system provides the After-Repair Valuations back to the user in formats that can support either the use of individual estimations or in aggregate by use of a geographic variable. An innovative feature of this system is the creation of subgroup-adjusted variables to increase the number of valid real estate comparables for the subject properties.

### CROSS-REFERENCE TO RELATED APPLICATION

This application claims priority under 35 U.S.C. § 119(e) to U.S. Provisional Patent Application No. 63/290,325, entitled “Predicting After Repair Property Values Using Natural Language Processing,” filed on Dec. 16, 2021 and hereby incorporated by reference herein in its entirety.

### FIELD OF THE INVENTION

This disclosure pertains to computer-implemented methods for estimating after-repair values (“ARVs”) of real estate properties, and more particularly, to computer-implemented methods for using machine learning and data from recently-renovated comparable real estate properties to estimate ARVs for residential real estate properties.

### BACKGROUND

“Redevelopers” are a type of real estate investor who purchases run-down or neglected properties, renovates them from the inside out to top market condition, and then sells the renovated property for a profit. Determining a subject property's ARV is an important early task before spending investment dollars on a possible renovation project. The ARV is the price that a given property would sell for on the open market if it were fully professionally renovated. If a redeveloper finds a distressed property, having an accurate prediction for ARV is vital in determining if he can make a profit in reselling the property after a renovation.

Estimating the ARV of a subject property is a more complicated process than estimating its current value. It requires filtering the available set of comparable properties ahead of time to only include renovated properties. The only available method of identifying renovated comparables is a tedious process that involves manually scrolling through recently sold properties and visually identifying signs of a renovation in the pictures or in the description text left by the real estate listing agent. The sold prices of these renovated comparables are then used as the basis for the subject property's ARV, with adjustments made for differences in the amount of square footage, beds, baths, and other features. Thus, there currently remains a need for a systematic method that rapidly determines ARV by identifying and filtering for appropriate comparables through the use of automated machine learning techniques prior to insertion into a valuation model.

### SUMMARY

By way of non-limiting example, aspects of the present disclosure are directed to methods for method for selecting a predictive model to predict the post-renovation value of real estate properties from real estate listings.

In accordance with aspects of the present disclosure, the disclosed computer-implemented method includes the steps of: a) collecting real estate listing and sales data for a set of real estate properties grouped in comparable clusters, b) identifying a set of unique tags included in the real estate listings, the set of unique tags being descriptive of property conditions, c) identifying a first subset of the set of unique tags that consistently indicate properties in a first subset of real estate properties with a renovated status, and a second subset of the unique tags that consistently indicate a second subset of properties in the set of real estate properties with an un-renovated status, d) training two or more mathematical models based on a remaining subset of the set of unique tags to predict a renovation status for each of the remaining properties in the set of real estate properties, e) determining a performance measurement for predictions made by each of the two or more mathematical models, and f) selecting one of the two or more mathematical models as the predictive model based on the performance measurements.

In accordance with an additional aspect of the disclosure, the comparable clusters are census tracts.

In accordance with further aspects of the disclosure, the performance measurement is an error rate.

In accordance with further aspects of the disclosure, the performance measurement is a run time.

This SUMMARY is provided to briefly identify some aspects of the present disclosure that are further described below in the DESCRIPTION. This SUMMARY is not intended to identify key or essential features of the present disclosure nor is it intended to limit the scope of any claims.

### BRIEF DESCRIPTION OF THE DRAWING

A more complete understanding of the present disclosure may be realized by reference to the accompanying drawing in which:

FIG. 1 presents a schematic view of steps in an ARV estimator process in accordance with aspects of the present disclosure.

FIG. 2 presents a schematic view illustrating a creation of subgroups of comparable properties for analysis;

FIG. 3 presents a table illustrating an example subset of properties for a shared subgroup combination;

FIG. 4 presents a table illustrating the types of information gained in using a difference from the median derivative of a core property characteristic, using ‘baths’ as an example;

FIG. 5 presents a table illustrating the types of information gained in using a subgroup standardization derivative of a core property characteristic, using ‘baths’ as an example;

FIG. 6 presents a schematic diagram illustrating training an SVM model with red circles representing renovated data and green squares representing non-renovated data;

FIG. 7 presents a schematic diagram further illustrating the SVM model of FIG. 6 and plotting a hyperplane maximizes margins between renovated and non-renovated data;

FIG. 8 presents a schematic diagram illustrating representational parts of a constructed classification tree algorithm;

FIG. 9 presents a schematic diagram illustrating a sample portion of a classification tree used to estimate the ‘ClosePrice’ variable in the data;

FIG. 10 presents a schematic diagram illustrating an example of a single property's ARV presented as part of a property app or web page display;

FIG. 11 presents a schematic diagram illustrating a map of calculated ARV medians and other data fields;

FIGS. 12A and 12B provide tables respectively showing top and bottom 15 term sets for predicting renovation status; and

FIG. 13 provides tables illustrating the impact of subgroup adjusted variables on prediction score error rates.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements later developed that perform the same function, regardless of structure.

Unless otherwise explicitly specified herein, the drawings are not drawn to scale.

Aspects of the present disclosure are directed to computer-implemented methods for using machine learning and data from recently-renovated comparable real estate properties to estimate After Repair property Values (“ARVs”) for residential real estate properties.

In accordance with aspects of the present disclosure, methods for data processing, model-based training and evaluations as further described herein may, for example and without limitation, be performed on a WINDOWS-based desktop computer equipped with 16 GB 1600 MHz DDR3, four Inter® Core™ i7-4790k CPUs @4.0 Ghz, and an NVIDIA GeForce GTX 970, programmed using the PYTHON programming language.

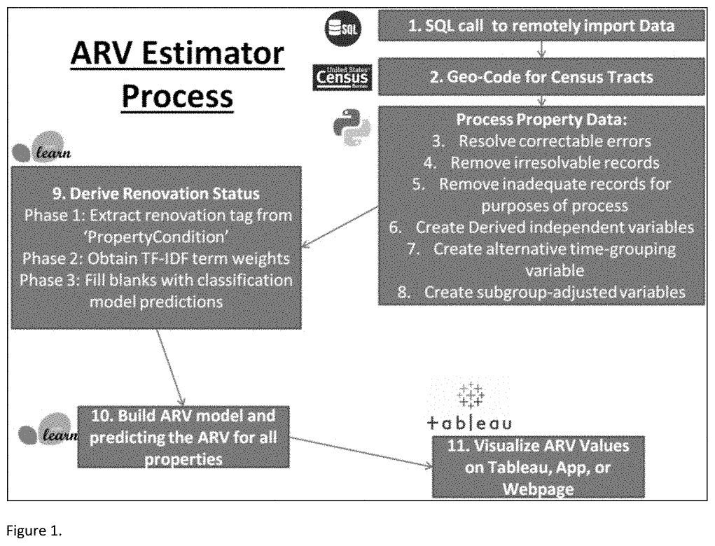

In accordance with further aspects of the present disclosure, exemplary methods for data processing, model-based training and evaluations may be described with reference to the following 15 steps (the first 10 of these steps are also shown in in FIG. 1).

Step 1—Structured Query Language (SQL) is a specialized software language for updating, deleting, and requesting information from databases. It is used to remotely import the raw data set of sold properties from established realtor databases. The subsequent steps provide detailed descriptions of the processing steps taken to clean and transform this data into a format usable by the machine learning models. A sample of the obtained data is shown below:

| Street address | City | State | ZIP | YearBuilt | Bath | Bedrooms | CloseDate |
|---|---|---|---|---|---|---|---|
| 71102 CROSS ROAD TRL | BRANDYWINE | MD | 20613 | 1951 | 1 | 3 | Nov. 22, 2017 |
| 10506 CEDELL PL | TEMPLE | MD | 20748 | 1965 | 3 | 4 | Oct. 15, 2017 |
| | HILLS | | | | | | |
| 18607 WHITEHOLM DR | UPPER | MD | 20774 | 1973 | 2 | 4 | Aug. 24, 2018 |
| | MARLBORO | | | | | | |
| 12303 JOSLYN PL | CHEVERLY | MD | 20785 | 1953 | 4 | 7 | Oct. 31, 2018 |
| 21496 OLD MARSHALL | ACCOKEEK | MD | 20607 | 1949 | 1 | 3 | Feb. 9, 2018 |
| HALL RD | | | | | | | |
| 21607 SAINT MARYS | AQUASCO | MD | 20608 | 1966 | 1 | 3 | Jan. 2, 2018 |
| CHURCH RD | | | | | | | |
| 83200 BENJAMIN | AQUASCO | MD | 20608 | 1959 | 1 | 2 | Nov. 14, 2018 |
| BANNEKER BLVD | | | | | | | |
| 15500 GRACE DR | CLINTON | MD | 20735 | 1956 | 2 | 4 | Feb. 23, 2018 |
| 9938 WARNER AVE | HYATTSVILLE | MD | 20784 | 1973 | 2 | 3 | Oct. 13, 2017 |
| 12400 HICKORY BND | CLINTON | MD | 20735 | 1984 | 3 | 4 | Mar. 9, 2018 |

| Street address | ClosePrice | PropertyCondition | PublicRemarks |
|---|---|---|---|
| 71102 CROSS ROAD TRL | 50000 | As-is Condition, | SOLD *AS IS*. NO ACCE [symbol] |
| | | Needs [symbol] | |
| 10506 CEDELL PL | 309000 | Shows Well | Must See Home! 4 Bedr [symbol] |
| 18607 WHITEHOLM DR | 245000 | As-is Condition | Cash or FHA 203K loans [symbol] |
| 12303 JOSLYN PL | 350000 | | Spectacular all brick 2 f [symbol] |
| 21496 OLD MARSHALL | 420000 | As-is Condition, | * PRIVACY NEXT TO NO [symbol] |
| HALL RD | | Needs [symbol] | |
| 21607 SAINT MARYS | 95500 | | Estate Sale. ENJOY THE [symbol] |
| CHURCH RD | | | |
| 83200 BENJAMIN | 36500 | | NEW PRICE!!! ALL OFFE [symbol] |
| BANNEKER BLVD | | | |
| 15600 GRACE DR | 282900 | | reduced price to sell fas [symbol] |
| 9938 WARNER AVE | 150000 | | Property sold strictly “as [symbol] |
| 12400 HICKORY BND | 295000 | | Wonderful opportunity [symbol] |

[symbol]

indicates data missing or illegible when filed

Step 2—Obtain Census Tract Information for each Record.
a. Census tracts are small, relatively permanent statistical subdivisions of a county or equivalent entity that are updated by local government participants prior to each decennial census as part of the Census Bureau's Participant Statistical Areas Program. Additional information on Census Tracts can be found at <https://www.census.gov/programs-surveys/geography/about/glossary.html#par_textimage_13>.
The census tract data for each real estate record is not typically stored in realtor databases and must instead be obtained using the census geocoder tool, an open-source Application Programming Interface (API) service provided by the U.S. Census Bureau at <https://geocoding.geo.census.gov/>. This API can be called with the open source Python® censusgeocode package to return the census tract data if passed either a set of properly formatted address variables or a set of Latitude/Longitude coordinate variables.
Additional information on the censusgeocode package can be found here:
1) Download location: https://pypi.org/project/censusgeocode/
2) Package Documentation: https://geocoding.geo.census.gov/geocoder/Geocoding_Services_API.pdf.
b. The geocoding of each property in the data by using the address variables is attempted first:
i. Step 1: Columns are filtered and formatted on a copy of the data to obtain the format for the address variables required by the censusgeocode package [‘Unique ID’, ‘Street address’, ‘City’, ‘State’, ‘ZIP’]. A sample of the batch file is displayed below:

| Unique ID | Street address | City | State | ZIP |
|---|---|---|---|---|
| 850 | 8029 ORLEANS ST | BALTIMORE | MD | 21231 |
| 851 | 921 FURROW ST S | BALTIMORE | MD | 21223 |
| 852 | 7800 SWANSEA RD | BALTIMORE | MD | 21239 |
| 853 | 9305 SPAULDING AVE | BALTIMORE | MD | 21215 |
| 854 | 7010 FAWN ST | BALTIMORE | MD | 21202 |
| 855 | 7529 BROADWAY | BALTIMORE | MD | 21213 |
| 856 | 8651 MILES AVE | BALTIMORE | MD | 21211 |
| 857 | 12129 CARDIFF AVE | BALTIMORE | MD | 21224 |
| 858 | 2113 BROADWAY | BALTIMORE | MD | 21213 |
| 859 | 3425 WENDOVER RD | BALTIMORE | MD | 21218 |

ii. Step 2: The formatted data is then chunked into batches of at most 10,000 records, the censusgeocode batch maximum. Each chunk of data is saved as its own comma-separated variable (csv) file.
iii. Step 3: Each csv file is fed into the censusgeocode API to identify the census tract for each record (a process known as “geocoding”). The API returns the geocoded data in the following format: [‘Unique ID’,‘address’,‘match’,‘statefp’,‘countyfp’,‘tract’,‘block’ ]. Each of the columns are described below
   1. Unique ID’: A unique identifying label for each row.
   2. address’: The previous address columns (Street address, City, State, and ZIP) merged together into a single field.
   3. match’: An indicator if a census tract was found for the address.
   4. ‘statefp’: An identification code for the state. For example, a “24” is the state code for Maryland.
   5. ‘countyfp’: An identification code for the county (or equivalent entity). For example, a “510” is the county code for Baltimore City.
   6. ‘tract’: An identification number for the census tract.
   7. ‘block’: A subdivision of a census tract. Currently unused.
   8. A sample of the geocoded data.

| Unique ID | address | match | statefp | countyfp | tract | block |
|---|---|---|---|---|---|---|
| 850 | 8029 ORLEANS ST, | TRUE | 24 | 510 | 060400 | 2013 |
| | BALTIMORE, MD, 21231 | | | | | |
| 851 | 921 FURROW ST S, | TRUE | 24 | 510 | 200500 | 4008 |
| | BALTIMORE, MD, 21223 | | | | | |
| 852 | 7800 SWANSEA RD, | TRUE | 24 | 510 | 270803 | 1034 |
| | BALTIMORE, MD, 21239 | | | | | |
| 853 | 9305 SPAULDING AVE, | TRUE | 24 | 510 | 271802 | 2005 |
| | BALTIMORE, MD, 21215 | | | | | |
| 854 | 7010 FAWN ST, | TRUE | 24 | 510 | 030200 | 2001 |
| | BALTIMORE, MD, 21202 | | | | | |
| 855 | 7529 BROADWAY, | TRUE | 24 | 510 | 080700 | 1007 |
| | BALTIMORE, MD, 21213 | | | | | |
| 856 | 8651 MILES AVE, | FALSE | | | | |
| | BALTIMORE, MD, 21211 | | | | | |
| 857 | 12129 CARDIFF AVE, | TRUE | 24 | 510 | 260605 | 2016 |
| | BALTIMORE, MD, 21224 | | | | | |
| 858 | 2113 BROADWAY, | TRUE | 24 | 510 | 080700 | 1007 |
| | BALTIMORE, MD, 21213 | | | | | |
| 859 | 3425 WENDOVER RD, | TRUE | 24 | 510 | 120100 | 1006 |
| | BALTIMORE, MD, 21218 | | | | | |

iv. Step 4: The ‘match’, ‘statefp’, ‘countyfp’, ‘tract’, and ‘block’ columns are joined to the original property data set by matching their ‘Unique ID’ column values.
v. Step 5: The above process is repeated until every batch of properties has been geocoded and rejoined to the original data set using the address variables
c. There will be some records that fail to find a matching census tract using the address variables. These records will be re-entered into the census geocoder API using their Latitude and Longitude coordinate variables to identify the census tract variables. The returned census tract variables are then joined directly to the property data set. No csv files are necessary as an intermediary step, these records can only be looped into the census geocoder API one at time. A sample of the latitude, longitude data prior to geocoding is shown below.

| Unique ID | Longitude | Latitude |
|---|---|---|
| 78200 | −77.18657 | 39.053013 |
| 79531 | −77.111 | 39.027702 |
| 79530 | −77.23612 | 39.09624 |
| 78202 | −76.98549 | 39.081104 |
| 79533 | −77.2755 | 39.171524 |
| 78201 | −77.01008 | 39.061638 |
| 79532 | −77.04673 | 39.100418 |

d. Records that fail to match with a valid census tract by either method are eliminated.

Step 3—Resolve Correctable Database Errors 1.

a. Implement miscellaneous standard formatting procedures like converting column data types, filling data gaps with acceptable values, etc.

Step 4—Remove Irresolvable Records. Data Records are Deemed Irresolvable if they:

a. Lack complete Address fields.
b. Lack viable ‘CloseDate’ value (zeros, blanks, erroneous dates, etc.).
c. Lack a numerical ‘ClosePrice’ value.
d. Have a value in the ‘City’ column that doesn't appear anywhere else. (City records with only a single property are almost always erroneous entries.).
e. Lack a numerical value for ‘AboveGradeFinishedArea’ and ‘TaxTotalFinishedSqFt’.

Step 5—Remove Records Inadequate for Purposes of Invention. Data Records are Deemed Inadequate if they:

a. Have a ‘YearBuilt’ value before a specified year stored as a variable (1900 is currently used). Houses built before this year make poor comparables for modern houses, regardless of renovation status.
b. Have a ‘YearBuilt’ value after a specified year stored as a variable (1990 is currently used). Recently built properties may have similar language and features to renovated properties but are valued quite differently by the marketplace.
c. Have a ‘PublicRemarks’ field with less than a minimum number of characters stored as a variable (30 is the currently used minimum). A minimum description of the property by the listing real estate agent is vital in determining renovation status.
d. Have a ‘StructureDesignType’ that is anything other than a detached single family residence or townhouse. This filter removes condos, duplexes, commercial properties, land, and apartments.) This process could be adapted to support many of these types of properties in the future.).

Step 6—Create Derived Independent Variables:

a. ‘GEOID’: Concatenates ‘statefp’, ‘countyfp’ and ‘tract’ into a single variable.
b. ‘FHAPurchaseBool’: 1 if ‘BuyerFinancing’ is “FHA”, otherwise 0.
c. ‘CashPurchaseBool’: 1 if ‘BuyerFinancing’ is “Cash”, otherwise 0.
d. ‘StandardSaleBool’: 1 if ‘SaleType’ is “Standard”, otherwise 0.
e. ‘EffectivelyNewBool’: 1 if “YearBuiltEffective” is the same as the “CloseYear.”
f. ‘Remarks char num’: A count of the number of characters in ‘PublicRemarks’.
g. ‘AboveGradeSqft_custom’: Fills in blanks of ‘AboveGradeFinishedArea’ with the values of the ‘TaxTotalFinishedSqFt’.

### h. ‘AboveSqftPerBaths’: =‘AboveGradeSqft_custom’/‘Baths’.

i. Blanks are filled in with the median value of the data set.
   i. ‘PropertyTaxRate’: Uses a loaded ‘county_to_tax_rate’ dictionary to identify the local tax rate for each property.
   j. ‘TaxAssessmentAmount_custom’: Fills in blanks with ‘TaxAnnualAmount’/‘PropertyTaxRate’.

### k. ‘TaxAssessmentperSqft_AboveGrade’:=‘TaxAssessmentAmount’/‘AboveGradeSqft_custom’.

l. ‘LotSizeAcres_custom’: Fills in blanks of the ‘LotSizeAcres’ variables with ‘LotSizeSquareFeet’/43560.
m. ‘attic’: 1 if “attic” is found in the text of ‘Storage’ or ‘PublicRemarks, otherwise 0.
n. ‘publicWater’: 1 if “public” is found in the text of ‘publicWater’, otherwise 0.
o. ‘GarageSpaces_custom’: Adds the values of ‘NumDetachedGarageSpaces’ and ‘DetachedNumGarageSpaces’ together. If blank, defaults to 1 if “garage” is found in the text of ‘ParkingFeatures’, otherwise defaults to 0.
p. ‘SFR’:1 If ‘StructureDesignType’ is ‘Detached’, otherwise 0.
q. ‘TH’: 1 if ‘StructureDesignType’ is “Row/Townhouse”, “End of Row/Townhouse”, or “Interior Row/Townhouse”, otherwise 0.
r. ‘porch’: 1 if “porch” is found in the text of ‘PatioandPorchFeatures’ or ‘PublicRemarks, otherwise 0.
s. ‘deck’: 1 if “deck” is found in the text of ‘PatioandPorchFeatures’ or PublicRemarks, otherwise 0.
t. ‘patio’: 1 if “patio” is found in the text of ‘PatioandPorchFeatures’ or ‘PublicRemarks, otherwise 0.
u. ‘brickStone_Bool’: 1 if “brick” or “stone” is found in the text of ‘ConstructionMaterials’, otherwise 0.
v. ‘finBsmt_Bool’: 1 if ‘BelowGradeFinishedArea’>1, otherwise 0.
w. ‘unfinBsmt_Bool’: 1 if ‘BelowGradeUnfinishedArea’>1, otherwise 0.
x. ‘annualizedAssociationFees’: A multiplication of the ‘AssociationFee’ column with a value depending on the ‘AssociationFeeFrequency’ variable. A table displaying the association fee frequency multiplication numbers are displayed below.
y ‘TH_EndUnit’: 1 if StructureDesignType is ‘End of Row/Townhouse’, otherwise 0.

### z. ‘SFR_Rambler’: 1 if StructureDesignType is ‘Detached’ and ‘ArchitecturalStyle’ is ‘Ranch/Rambler’.

### aa. ‘SFR_Colonial: 1 if StructureDesignType is ‘Detached’ and ‘ArchitecturalStyle’ is ‘Colonial’.

Step 7—Create Alternative Time-Grouping Variable:

a. ‘roller_12month_group’: A 12-month rolling variable where the most recent 12 months of data is given a “group 1” value, the previous 12 months are given a “group 2” value, etc. This variable will be used as an alternative time grouping variable to ‘year’ for the machine learning models. The ‘roller_12month_group’ guarantees that processing newly added properties will automatically be grouped with a full 12 months of data.

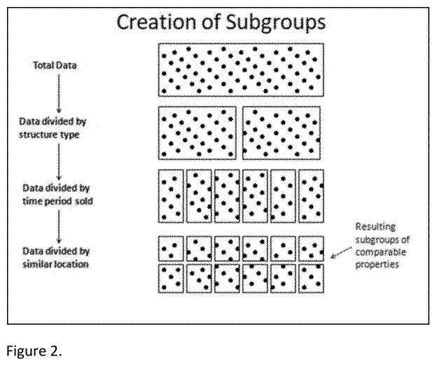

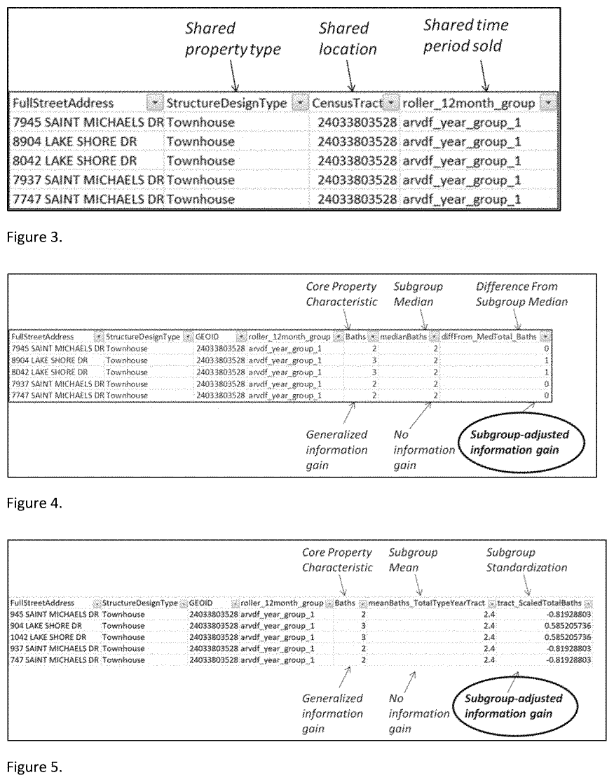

Step 8—Create Subgroup-Adjusted Variables:
a. Step 1: Divide the property data set into subgroups of comparable properties:
   i. A variety of different filtering criteria can be used to identify subgroups of properties similar enough in order to be used as comparables for each other. However, through testing, best results were found when subgroups of properties shared similar values in the following three criteria: structure type, location, time period sold. A diagram illustrating the creation of subsets of properties is shown in FIG. 2. FIG. 2 illustrates a subgrouping process which divides the data by unique pairings of their structure type, time period sold, and location
   ii. While a variety of variables could be used as proxies for each of these filtering criteria, the best results were found with the following variables: ‘StructureDesignType’ for structure type, ‘GEOID’ for location, and ‘roller_12_month_group’ for time period sold.
   iii. An example subset of properties filtered to a shared subgroup combination of ‘StructureDesignType’, ‘GEOID’, and ‘roller_12_month_group’ is shown in FIG. 3.
b. Step 2: Select the Core Set of Property Characteristic Variables.
   i. Through extensive testing of model performance, property characteristic variables were selected to derive the subgroup-adjusted variables. Subgroup-adjusted variables were derived from each of these core property characteristic variables. The core set of property characteristics that yielded the best performance increases in the models are listed below.
      1. ‘Baths’,‘BedroomsTotal’,‘AboveGradeSqft_custom’, ‘LotSizeAcres_custom’,‘GarageSpaces_custom’, ‘ClosePrice’,‘PriceperSqft_AboveGrade’,‘YearBuilt’,‘TaxAssessmentAmount_custom’,‘TaxAssessmentperSqft_AboveGrade’, and ‘AboveSqftPerBaths’.
   ii. The difference from the median (d) is calculated simply as the value of the specified variable for a subject property (x) minus the median value (X) of all properties in the same subgroup as the subject property.

d=x−\hat{x}
1. For example: take the subgroup of properties that is made up of townhouses sold in the ‘GEOID’ of “24033803528” with the ‘roller_12month_group’ values of “arvdf_year_group_1”. This subgroup contains three properties with two full baths and two properties with three full baths. The resulting median number of baths for this subgroup is 2. The subgroup median alone doesn't add much in the way of differential information for a machine learning model. However, the difference from the median number of baths can be obtained when the subgroup median number of baths is subtracted from the actual number of baths in each property. The difference from the median baths variable provides new information to the machine learning models by interpreting how far each property's bath count deviates from the subgroup's median bath count. An example using the difference from the median baths is illustrated in FIG. 4.
ii
   variable (x), subtracting their subgroup means (μ), and then dividing by its standard deviation (s). This process is automated in Python® by using the “StandardScaler( )” function from the sklearn Python® package. The formula of which is shown below. Additional information on the sklearn package can be found in the documentation at https://scikit-learn.org/stable/user_guide.html.

$$z = \frac{x - μ}{s}$$

iv. For example: The mean number of baths of a subgroup of townhouses sold during the ‘arvdf_year_group_1’ time period in the ‘GEOID’ of 24033803528 is 2.4. A property whose number of baths is greater than 2.4 will have a positive value for ‘tract_ScaledTotalBaths’. Likewise, a property whose number of baths is less than 2.4 will have a ‘tract_ScaledTotalBaths’ value of less than 0. The standardization from the mean baths example is illustrated in FIG. 5.

Step 9—Determining Renovation Status for all Database Rows:Offer Information.
a. Explanation: Only recently renovated properties are appropriate comparables for determining the ARV. As such, the renovation status of properties at the time of their sale needs to be identified in order to make an ARV model. The renovation status is derived and stored in the ‘renovation’ column as a Boolean variable, where a “1” indicates that the property was recently renovated before being sold to a new buyer. A “0” indicates all other cases. Deriving the renovation status for each property occurs in three phases: Extracting renovation status from the ‘PropertyCondition’ column tags (when it's possible), obtaining the term frequency-inverse document frequency (TF-IDF) matrix as independent variables, and training a classification model to fill ‘renovation’ column gaps.
b. Determining Renovation Status Phase 1: Extracting renovation status from the ‘PropertyCondition’ column tags.
   i. The ‘PropertyCondition’ column contains hundreds of unique tags summarizing the condition of the property by the listing agent at the time the property is listed for sale. This column is only filled in about 45% of the time. The table below displays a data view that shows the blanks in the “PropertyCondition’ column.

| Unique ID | PropertyCondition | renovation | PublicRemarks |
|---|---|---|---|
| 192433 | As-is Condition, | 0 | SOLD *AS IS*. NO ACCESS TO THE HOUSE. LEVEL LOT |
| | Needs Work | | IN GREAT LOCATION! PARCE [symbol] |
| 192433 | Very Good | | Must See Home! 4 Bedroom 3 Full Bath Detached |
| | | | Rambler in a family based commun [symbol] |
| 192433 | As-is Condition | 0 | Cash or FHA 203K loans only. Water is not available |
| | | | for inspections. Buyer pays outst [symbol] |
| 192433 | | | Spectacular all brick 2 family home. 2 updated kitchens |
| | | | shows like a model home, grea [symbol] |
| 192433 | As-is Condition, | 0 | * PRIVACY NEXT TO NONE * HOUSE NEEDS REHAB * SOLD |
| | Needs Work | | AS IS * COVERED STRUCT [symbol] |
| 192433 | Renov/Remod | 1 | Stunning Colonial sits on a ½ acre/corner lot. |
| | | | This tastefully remodeled home w/lot [symbol] |
| 192433 | | | NEW PRICE!!! ALL OFFERS WILL BE CONSIDERED!!! |
| | | | A country setting featuring 2 bed [symbol] |
| 192433 | | | reduced price to sell fast!! PROPERTY HAS |
| | | | APPRAISED FOR 295k!! AS-is!!! for info [symbol] |
| 192433 | | | Property sold strictly *as-is*. Cash or 203K preferred. |
| 192433 | | | Wonderful opportunity to renovate this property to |
| | | | your taste. Almost 4,000 square [symbol] |
| 192433 | As-is Condition | 0 | Spacious split foyer on large corner lot! Updated |
| | | | eat in kitchen, large living room, [symbol] |
| 192433 | Major Rehab Needed | 0 | JUST REDUCED!!!!! CASH ONLY TRANSACTIONS! |
| | | | HOUSE NEEDS LOTS OF WORK ENT [symbol] |
| 192433 | | | MOTIVATED SELLER - Nicely renovated (2008), 4 Bedroom |
| | | | property with bedroom [symbol] |
| 192433 | As-is Condition | 0 | This lovely single family home is ready for your buyer. |
| | | | Home owner is very meticulous [symbol] |
| 192433 | Renov/Remod | 1 | PRICE REDUCTION. Fully remodeled Cape Cod, Tudor-style |
| | | | exterior, with 4-bedrooms [symbol] |

[symbol]

indicates data missing or illegible when filed

ii. Properties with the “Renov/Remod” tag were labeled as a “1” under the newly derived ‘renovation’ field. From manual inspection, it was discovered that this was the only tag that denoted properties that were consistently sold as new renovations.
iii. Conversely, a list of less flattering tags that typically denote poorer property condition such as “Major Rehab Needed”, “Needs Work”, and “As-is Condition, Shows Well” were compiled. Properties with these tags were given a ‘renovation’ column value of “0”.
iv. The remaining tags were found to be inconsistent in determining renovation status and could not be used to consistently identify a “1” or a “0” for the ‘renovation’ column. For example, an examination of properties tagged as “Very Good” found both newly renovated properties and non-renovated properties. The ‘renovation’ column values were left blank for properties with these indeterminate tags. As a result, the ‘renovation’ column could be determined definitively as a “1” or a “0” for about 13% of the 337,803 evaluated properties, while the rows for this column are left blank for the other 87%.
c. Determining Renovation Status Phase 2: Obtain the TF-IDF matrix
   i. Explanation: The purpose of Phase 2 is to use the property descriptions left by the agent in the ‘PropertyRemarks’ column to build a term frequency-inverse document frequency (TF-IDF) matrix to identify key terms or phrases to differentiate between the renovated and non-renovated properties. The features in the TF-IDF matrix will be used as independent variables for the renovation classification model in Phase 3. This procedure is described in greater detail below.
   iii. Step 2: Obtain the TF-IDF matrix from the text descriptions in the ‘PropertyRemarks’ column of the first set of data.
   1. Explanation: If the property has been recently renovated, the listing agent will typically describe it in the ‘PropertyRemarks’ column with phrases such as “sparkling renovation” or “newly installed granite”. The TF-IDF technique scales up the value of rarely used terms or phrases such as “granite countertops” and scales down the value of commonly used terms such as “property”, resulting in a TF-IDF matrix of terms and weights.
   2. The TF-IDF matrix is calculated by computing the term frequency (tf) matrix and the inverse document frequency (idf) matrix before multiplying them together. The TF-IDF computation steps are briefly outlined below.
      a. For each row, t, of the ‘PropertyRemarks’ column, the tf is calculated simply as the raw count of a term, c, that appears divided by the total number of terms, z:

$$tf ( t ) = \frac{c ( t )}{z ( t )}$$

b. The idf for each row, t, is calculated as the log of the following: the number of rows, n, divided by the number of rows containing the specified term, df(d,t), plus 1:

$$idf ( t ) = log ( \frac{n}{df ( d , t ) + 1} )$$

c. Multiplying the tf and idf matrices together yields the TF-IDF matrix.

tfidf=tf*idf
3. A simplified example of the TF-IDF calculation steps from PropertyRemarks' text is displayed in the table below.

PropertyRemarks

The townhouse contains a sparkling granite kitchen
The townhouse contains a granite kitchen
The townhouse contains a kitchen

a. Identify the term counts, c. Note that words commonly used in the English language such as “the” and “a” are dropped. The remaining word counts for the example are displayed in the table below.

| Terms | Count |
|---|---|
| townhouse | 3 |
| sparkling | 1 |
| granite | 2 |
| kitchen | 3 |

b. Identify the term totals, z. The term totals for the example are displayed in the table below.

| PropertyRemarks | Term Totals |
|---|---|
| The townhouse contains a sparkling granite kitchen | 7 |
| The townhouse contains a granite kitchen | 6 |
| The townhouse contains a kitchen | 5 |

c. Calculate the tf matrix. The tf matrix table for the example is displayed below.

| | Term Frequency | | |
|---|---|---|---|
| | The townhouse | | |
| | contains a | The townhouse | |
| | sparkling | contains a granite | The townhouse |
| Row Terms | granite kitchen | kitchen | contains a kitchen |
| townhouse | 1/7 | 1/6 | 1/5 |
| sparkling | 1/7 | 0/6 | 0/5 |
| granite | 1/7 | 1/6 | 0/5 |
| kitchen | 1/7 | 1/6 | 1/5 |

d. Calculate the idf matrix. The results of the calculated idf matrix for the example are displayed in the table below.

| Terms | Inverse Document Frequency |
|---|---|
| townhouse | log(3/4) = −0.1249 |
| sparkling | log(3/2) = +0.1761 |
| granite | log(3/3) = 0.000 |
| kitchen | log(3/4) = −0.1249 |

e. Finally, multiply the tf matrix by the idf matrix to obtain the tf-idf matrix. The final tf-idf results for the example are displayed in the table below.

| | TF-IDF | | | |
|---|---|---|---|---|
| Property Remarks | townhouse | sparkling | granite | kitchen |
| The townhouse | 1/7 * (−0.1249) = −0.0178 | 1/7 * (0.1761) = 0.0252 | 1/7 * (0.0) = 0.0 | 1/7 * (−0.1249) = −0.0178 |
| contains a sparkling | | | | |
| granite kitchen | | | | |
| The townhouse | 1/6 * (−0.1249) = −0.0208 | 0/6 * (0.1761) = 0.0 | 1/6 * (0.0) = 0.0 | 1/6 * (−0.1249) = −0.0208 |
| contains a granite | | | | |
| kitchen | | | | |
| The townhouse | 1/5 * (−0.1249) = −0.0245 | 0/5 * (0.1761) = 0.0 | 0/5 * (0.0) = 0.0 | 1/5 * (−0.1249) = −0.0245 |
| contains a kitchen | | | | |

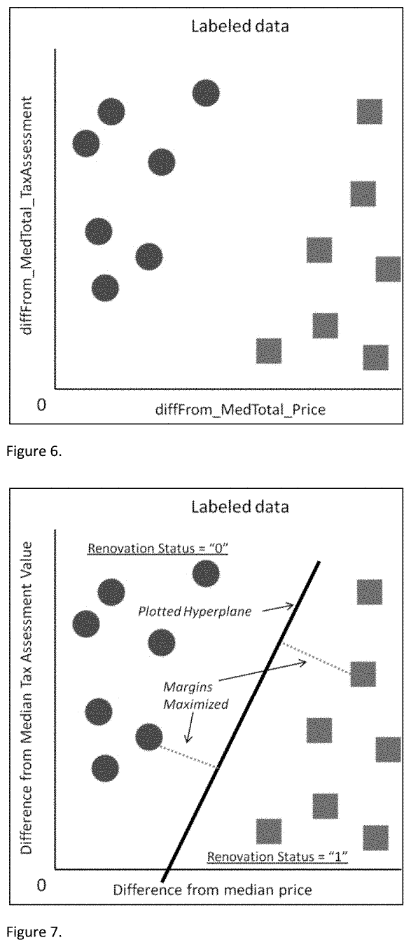

f. The TfidfVectorizer( ) function from the scikit-learn Python® package simplifies this process by allowing for easy generation of the TF-IDF matrix with a single line of code. The line of code and description of the selected parameters are provided below.
   i. |cv::TfidfVectorizer(stop_words::‘english’, ngram_range::(1,2))
   ii. stop_words=‘english’: Simply turns on the default filtering of common articles used in the English language like “a”, “and”, and “the” before processing the TF-IDF matrix.
   iii. ngram_range=(1,2): This setting sets the TfidVectorizer to search for word phrases made up of one or two words.
g. Additional information on the TfidfVectorizor( ) function of the scikit-learn package can be found in the documentation at https://scikit-learn.org/stable/modules/generated/sklearn.feature_extraction.text.TfidfVectorizer.html.
h. For more information on the construction and use of the TF-IDF matrix, please see chapter 8 in Python Machine Learning: Machine Learning and Deep Learning with Python, scikit-learn, and TensorFlow by Sebastian Raschka and Vahid Mirjalili.
4. The TF-IDF matrix is converted from a sparse matrix into a dataframe where each word or phrase is a feature with a TF-IDF value for each row. This dataframe, which now includes thousands of TF-IDF features, is appended onto the training data set. The appended features are included as some of the independent variables in the classification model to predict the missing values of the ‘renovation’ column. The TF-IDF features and subgroup-adjusted features together form a robust independence variable set for a classification model to predict the missing values of the ‘renovation’ column.
5. Note: There are many alternative Natural Language Processing (NLP) techniques for processing text into a format usable by machine learning algorithms, including but not limited to word2vec or BERT (Bidirectional Encoder Representations from Transformers).
d. Determining Renovation Status Phase 3: Train a classification model to predict a “1” or a “0” for the blank values of the ‘renovation’ column.
   i. Filter the independent variables of the training data to only include those with predictive power for the renovation classification model.
      1. The TF-IDF features were crucial in providing independent variables useful in predicting a property's renovation status and were used in the training of the renovation classification model.
      2. The raw property characteristics (‘sqft’, ‘baths’, ‘beds’, etc.) had very little ability to predict a property's renovation status and were not used in the training of the renovation classification model.
      3. A few of the derived variables were able to improve the model's classification scores due to interpreting the property physical characteristics in a subgroup-specific context. The derived variables used in the renovation classification model are listed below.
         a. ‘EffectivelyNewBool’, ‘StandardSaleBool’, ‘diffFrom_MedTotal_Price’, ‘diffFrom_MedTotal_TaxAssessmentPerSqft’, ‘diffFrom_MedTotal_PricePerSQFT’, ‘tract_ScaledTotalPrice’, ‘tract_ScaledTotalBaths’
   ii. While many algorithms could be used as the renovation classification model, best results were found with the support-vector machine (SVM) algorithm. The essentials of how SVM models are trained are best shown with a simplified example.
      1. In FIG. 6 below, the red circles represent the labeled training data with a ‘renovation’ value of “0” while the green squares represent the labeled training data with a ‘renovation’ value of “1”. This simplified example only uses two independent variables to predict the renovation values, ‘diffFrom_MedTotal_TaxAssessment’ on the y-axis and ‘diffFrom_MedTotal_Price’ on the x-axis.
      2. The goal of the SVM classification model is to plot a hyperplane to correctly identify a “1” or “0” value for each set of coordinates. The SVM takes these data points and outputs the hyperplane (which in two dimensions is simply a line) that separates the renovation tags. The hyperplane is also called the decision boundary, everything that falls on one side of it will be classified as “1” and anything that falls on the other side as “0”. For SVM, the optimal hyperplane is the one that maximizes the margins from both sets of tags. Another way of saying this is that the hyperplane that creates the most distance between the nearest element of each tag is the hyperplane that is selected for classifying new data. An example of a plotted hyperplane classifying the labeled data is plotted below.
      3. While the above example only uses two variables to predict renovation status, the SVM process can be scaled up to include many variables by adding an additional dimension for each variable. This technique is used with hundreds of variables to predict the renovation status of thousands of properties.
      4. The LinearSVC( ) function from the scikit-learn Python® package simplifies this process by allowing for easy generation of the SVM algorithm with a single line of code. The line of code and description of the selected parameters are provided below.

|svm_lin=LinearSVC(class_weight=‘balanced’)
a. class_weights=‘balanced’: The ‘balanced’ parameter tells the model to automatically adjust the weights inversely proportional to class frequencies in the input data.
iii. Train the renovation classification model with the SVM algorithm using the tagged training data.
   1. The LinearSVC( ) function from the scikit-learn Python® package simplifies the training process into just a single line of code, as displayed below.

svm_lin.fit(_X_train,_y_train)
2. Where ‘_X_train’ is a dataframe containing the non-blank values for the independent variables for the renovation labeled data.
3. Similarly, ‘_y_train’ is a one column dataframe containing the dependent variable, ‘renovation’, for the renovation labeled data.
iv. Once the renovation classification model is trained with the labeled training data, it is used to predict the blanks in the ‘renovation’ column, resulting in a fully renovation-tagged data set.
   1. The LinearSVC( ) function from the scikit-learn Python® package simplifies the prediction process into just a single line of code, as displayed below.

df_test.loc[:,‘bestModel_reno’]=svm_lin.predict(_X_test)
2. The ‘_X_test’ variable contains the independent variables for the untagged data (ie. blanks in the ‘renovation’ column). Now that the classification model has been trained using the labeled data, it is time to predict the ‘renovation’ status of the unlabeled data using the independent variables from the ‘_X_test’ dataframe. The predictions are used to fill in the blanks of the ‘renovation’ column, as shown in the table below.

| Unique ID | PropertyCondition | Renovation | PublicRemarks |
|---|---|---|---|
| 192433 | As-is Condition, | 0 | SOLD *AS IS*. NO ACCESS TO THE HOUSE. LEVEL LOT |
| | Needs Work | | IN GREAT LOCATION! PARCEL [symbol] |
| 192433 | Very Good | 1 | Must See Home! 4 Bedroom 3 Full Bath Detached |
| | | | Rambler in a family based communi [symbol] |
| 192433 | As-is Condition | 0 | Cash or FHA 203K loans only. Water is not available |
| | | | for inspections. Buyer pays outst [symbol] |
| 192433 | | 0 | Spectacular all brick 2 family home. 2 updated kitchens |
| | | | shows like a model home, grea [symbol] |
| 192433 | As-is Condition, | 0 | * PRIVACY NEXT TO NONE * HOUSE NEEDS REHAB * SOLD |
| | Needs Work | | AS-IS * COVERED STRUCT [symbol] |
| 192433 | Renov/Remod | 1 | Stunning Colonial sits on a ½ acre/corner lot. |
| | | | This tastefully remodeled home w/lot [symbol] |
| 192433 | | 0 | NEW PRICE!!! ALL OFFERS WILL BE CONSIDERED!!! |
| | | | A country setting featuring 2 bed [symbol] |
| 192433 | | 1 | reduced price to sell fast!! PROPERTY HAS |
| | | | APPRAISED FOR 295k!! AS-Is!!! for info [symbol] |
| 192433 | | 0 | Property sold strictly “as-is”. Cash or 203k preferred. |
| 192433 | | 0 | Wonderful opportunity to renovate this property to |
| | | | your taste. Almost 4,000 square [symbol] |
| 192433 | As-is Condition | 0 | Spacious split foyer on larger corner lot! Updated |
| | | | eat in kitchen, large living room, hard [symbol] |
| 192433 | Major Rehab Needed | 0 | JUST REDUCED!!!!! CASH ONLY TRANSACTIONS! |
| | | | HOUSE NEEDS LOTS OF WORK. ENTR [symbol] |
| 192433 | | 0 | MOTIVATED SELLER - Nicely renovated (2008), 4 Bedroom |
| | | | property with bedroom an [symbol] |
| 192433 | As-is Condition | 0 | This lovely single family home is ready for your buyer. |
| | | | Home owner is very meticulous [symbol] |
| 192433 | Renov/Remod | 1 | PRICE REDUCTION. Fully remodeled Cape Cod, Tudor-style |
| | | | exterior, with 4 bedrooms [symbol] |

[symbol]

indicates data missing or illegible when filed

3. The training and testing dataframes are recombined back into a single data set that now has the ‘renovation’ column filled entirely with the non blank values of “1”s or “0”s. It is now possible to build an ARV model with the entire data set instead of just the 13% that was previously tagged.
v. There are many alternative algorithms that could be used to predict renovation status, including but not limited to: SGDClassifier, RandomForestClassifier, and deep learning techniques.
vi. For more information on the construction and use of support vector classifiers, please see chapter 10 in Python Machine Learning: Machine Learning and Deep Learning with Python, scikit-learn, and TensorFlow by Sebastian Raschka and Vahid Mirjalili.
   1. Raschka, S., & Mirjalili, V. (2017). Python Machine Learning: Machine Learning and Deep Learning with Python, scikit-learn, and TensorFlow (Second). Packt Publishing.
vii. For more information on the construction sklearn's LinearSVC algorithm, please see the documentation at https://scikit-learn.org/stable/modules/generated/sklearn.svm.LinearSVC.html
viii. For a more in depth explanation of the theory or inner workings of the Linear SVM in Python® see <https://www.analyticsvidhya.com/blog/2017/09/understaing-support-vector-machine-example-code/>.

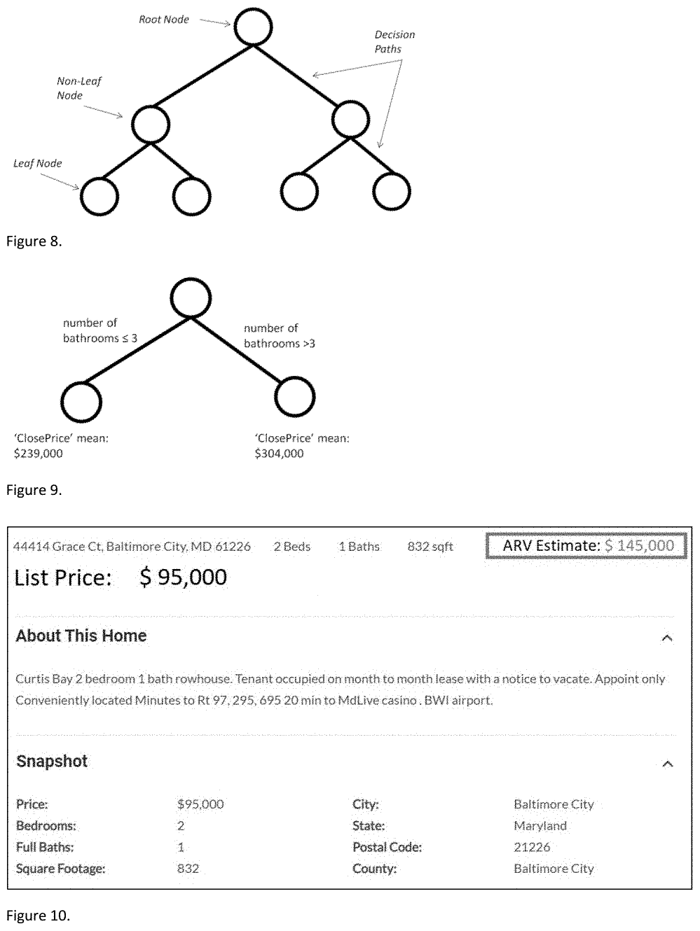

Step 10—Building the ARV Model and Predicting the ARV of Each Property.
a. Explanation: With the renovation status gaps filled, the ARV price prediction models can now be built based on significantly more data. The best results were found using the Extra Trees Regressor algorithm as the ARV regression model. An explanation of how the Extra Trees Regressor algorithm works is described below.
   i. The Extra Trees Regressor is one of several models that uses a “forest” of classification trees. For each of the trees in the forest, the dependent variable and a randomly selected fraction of the independent variables are chosen to construct a classification tree. In the constructed classification tree, each non-leaf node represents a decision stump for differentiating properties based on one of the selected attributes. The root node is simply the first non-leaf node in the tree. A leaf node is a node that has no subtrees of its own. The leaf nodes of the tree cumulatively represents all data in the training set whose independent variable values corresponding to the decision paths from the tree's root node to the leaf node. The leaf nodes are weighted based on the mean of the dependent values whose attributes correspond to that particular leaf node. An example of the classification tree structure is shown in FIG. 8.
   ii. For a non-leaf node example, if the selected attribute is the number of bathrooms, the node may represent the decision stump of “number of bathrooms ≤3”. This node therefore defines two subtrees with which to split the data: one subtree in which every property has 3 bathrooms or less, and a second subtree in which each property has 4 bathrooms or more. For each subtree of data, the mean of the dependent variable (in this case, ‘ClosePrice’) is carried forward. This process would be repeated many times to create a forest of classification trees. A node example with its decision paths and the resulting ‘ClosePrice’ means after the data split is illustrated in FIG. 9.
   iii. Each classification tree in a forest is built with the following rules:
      1. All the data available in the training set is used to build each classification tree.
      2. To form any node, including the root node, the best split is determined by searching in a subset of randomly selected features whose size is equal to the square root of the total number of features. The split of each selected feature is chosen at random.
      3. The maximum depth of the decision stump is always one.
   iv. The ExtraTreesRegressor( ) function from the scikit-learn Python® package simplifies this process into just a single line of code. The line of code and its selected parameters are described below.

reg_rf=ExtraTreesRegressor(n_jobs=3,min_samples_leaf=2,min_samples_split=5)
1. n_jobs=3: The number of processing jobs that are run in parallel. As the hardware used to compute this algorithm has 4 CPUs, a maximum of 3 could be tasked with parallel processing jobs without significantly slowing down the desktop's response in other tasks. The variable should be scaled as needed depending on the number of available CPUs.
2. min_samples_leaf=2: Sets the minimum number of samples required to be a lead node. This parameter helps to reduce to creation of unnecessary subtrees and smooth the regression model.
3. min_samples_split=5: Sets the minimum number of samples required to split an internal node to 5. This parameter helps to reduce to creation of unnecessary subtrees.
v. For more information on the construction of tree based regression models, please see chapter 10 in Python Machine Learning: Machine Learning and Deep Learning with Python, scikit-learn, and TensorFlow by Sebastian Raschka and Vahid Mirjalili.
   1. Raschka, S., & Mirjalili, V. (2017). Python Machine Learning: Machine Learning and Deep Learning with Python, scikit-learn, and TensorFlow (Second). Packt Publishing
vi. For more information on the use of the Extra Trees regression model implemented in sklearn, please see the documentation at <https://scikit-learn.org/stable/modules/generated/sklearn.ensemble.ExtraTreesRegressor.html>.
vii. For more information on the calculations of the Extra Trees regression algorithm see https://towardsdatascience.com/an-intuitive-explanation-of-random-forest-and-extra-trees-clssifiers-8507ac21d54b
viii. Note: There are many alternative algorithms that could be used to predict ARV, including but not limited to: LinearRegression, RandomForestRegression, and deep learning techniques.
b. Train the ARV regression model with the Extra Trees Regressor algorithm:
   i. Step 1: Create a new data set called ‘renovated data’, by filtering the total data set to only properties that have a ‘renovation’ column value of “1”. The result is a set of renovated properties whose sold prices will be used to train the ARV regression model.
   ii. Step 2: Re-run the code to generate the subgroup-adjusted variables.
      1. Explanation: The available data for each subgroup has been changed due to filtering the data to only renovated properties, so the subgroup-adjusted variables need to be re-generated.
   iii. Step 3: Filter the data variables to remove independent variables that been observed in testing to have little to no predictive power in ARV regression models. The independent variables that have demonstrated predictive power and remain in the data set are listed below.
      1. ‘SFR’, ‘tract_ScaledTotalBeds’, “tract_ScaledTotalBaths”, “tract_ScaledTotalYearBuilt”, ‘medianPrice_TotalTypeYearTract’, ‘diffFrom_MedTotal_Baths’, ‘diffFrom_MedTotal_Beds’, ‘diffFrom_MedTotal_YearBuilt’, ‘diffFrom_MedTotal_AboveSqftPerBaths’, ‘diffFrom_MedTotal_Lot’, ‘diffFrom_MedTotal_SqftPerc’, ‘diffFrom_MedTotal_LotPerc’, ‘AboveGradeSqft_custom’, ‘BedroomsTotal’, ‘Baths’, ‘GarageSpaces_custom’, ‘YearBuilt’, ‘TH_EndUnit’, ‘SFR_Rambler’, ‘SFR_Colonial’, ‘annualizedAssociationFees’, ‘brickStone_Bool’, ‘unfinBsmt_Bool’, ‘porch’, ‘deck’, ‘AboveSqftPerBaths’, ‘BelowGradeFinishedArea’, ‘Remarks char num’, and ‘TotalPhotos’.
   iv. Step 4: Train the ARV regression model with the Extra Trees algorithm using the renovated data. The ExtraTreesRegressor( ) function from the scikit-learn Python® package simplifies this process into just a single line of code, as displayed below.

reg_rf.fit(_X_reno,_y_reno
1. Where ‘_X_reno’ is a dataframe containing the independent variables for the renovated data.
2. Similarly, ‘_y_reno’ is a one column dataframe containing the dependent variable, ‘ClosePrice’ for the renovated data.
v. Step 5: Once the ARV regression model is trained with the renovated data, it is used to predict the ARV values for all properties in the total data set. This way, even non-renovated properties will have an ARV estimate. The ExtraTreesRegressor( ) function from the scikit-learn Python® package simplifies this process into just a single line of code, as displayed below.

|df_total.loc[:,‘ARV’]=reg_rf.predict(_X)
1. The ‘_X’ variable contains the independent variables for the entire data set, including non-renovated properties.
2. The ARV regression model predicts the ARV using the independent variables from the ‘_X’ dataframe. The predictions are stored in the ‘ARV’ column

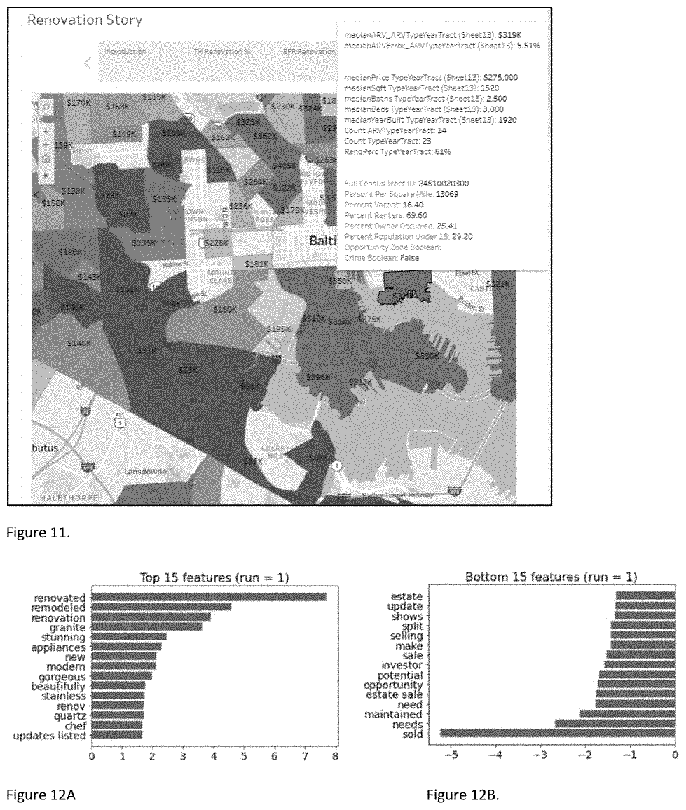

Step 11—Mediums to Display the ARV.
a. Now that the ARV is estimated for every single property in the total data set, it is possible to display or aggregate this data in multiple mediums. For instance, a specific property's ARV can be displayed individually on an app or web page, as illustrated in FIG. 10.
b. The ARV data can also be aggregated by geographic variable and displayed on a map, either by itself or part of a set of descriptive variables. For example, FIG. 11 demonstrates a displayed map of the ARV medians by census tract in Tableau®. Key property and demographic data for each census tract are available on mouse over. The link to the Tableau® map is located at <https://public.tableau.com/app/profile/joe8009/viz/PublishedRenovationStory/RenovationStory>.

Step 12—Results and Evaluation Methods of the Renovation Classification Models.
a. There are many classification models and parameter tuning setups that could be used to predict the ‘renovation’ status of properties. While not strictly a necessary step, it is advised to test and evaluate the results of several different algorithms to find an optimal model setup.
b. The data processing steps of evaluating renovation classification model performances are nearly the same as those in implementing the renovation model. The only difference is that the renovation data is split into two sets prior to training the model in order to test the results of the model on a separate subset of data that it was trained on. Results were obtained by splitting the data into training and testing sets on an 80/20 split (other splits are acceptable). The training set of data is used to train the ‘renovation’ classification model the same way it is implemented in the system. The trained model is now used to predict the ‘renovation’ status of the testing set of data. The ‘renovation’ prediction results are compared with the known ‘renovation’ results in order to generate metrics to evaluate the predictive power of the classification model being evaluated. This process was repeated with many different algorithms and parameters to see which model setup gave the best prediction metrics. The model that produces the best prediction metrics will be the one that is used to fill in the blanks for the ‘renovation’ status column in the finished system.
c. Accuracy is the standard metric for evaluating performance of binary classification models. However, the class balance of the dependent variable, ‘renovation’, is imbalanced with 15% of the labeled properties having a ‘renovation’ status of “1” and 85% of the labeled properties having a ‘renovation’ status of “0”. While Accuracy is sufficient for evaluating classification models with balanced data classes, it is appropriate to include the F1-score metric along with Accuracy for classification models with imbalanced classes. The F1-score is a measure balancing the statistical metrics of Precision (measure of correct positive cases from all predicted positive cases) and Recall (measure of correct positive cases from all actual positive cases). Both the Accuracy and F1-score metrics will be used to evaluate the performance of the renovation classification models. For more information on the construction and use of Accuracy, F1-score, or other evaluation metrics for classification models, see chapter 6 in Python Machine Learning: Machine Learning and Deep Learning with Python, scikit-learn, and TensorFlow by Sebastian Raschka and Vahid Mirjalili.
   i. Raschka, S., & Mirjalili, V. (2017). Python Machine Learning: Machine Learning and Deep Learning with Python, scikit-learn, and TensorFlow (Second). Packt Publishing
d. The algorithms tested for the renovation classification model are: LinearSVC, RandomForestClassifier, ExtraTreesClassifier, SGDClassifier, and LogisticRegression. Many other algorithms exist that could have been tested. The table below displays the evaluation metrics and run times of the renovation classification model results.

| | | | Run Time |
|---|---|---|---|
| Classification Model | F1score | Accuracy | (seconds) |
| Linear SVC | 0.838 | 0.950 | 28.4 s |
| Logistic Regression Classifier | 0.836 | 0.948 | 37.2 s |
| Extra Trees Classifier | 0.818 | 0.942 | 35.3 s |
| SGD Classifier | 0.818 | 0.938 | 17.1 s |
| Random Forest Classifier | 0.817 | 0.944 | 34.8 s |

e. The Linear Support Vector Classifier (Linear SVC) model was the best performing model, boasting the best F1 score, the best accuracy, and the second quickest run time. The Logistic Regression model stood just a hair behind the Linear SVC, occasionally overtaking it depending on how the hyperparameters were tuned.
f. This selection of models was chosen in part because of their ability to show the user the ranking of which terms most heavily influenced the model. The Linear SVC model has the added bonus of ranking features both positively and negatively. Properties with positively ranked features are more likely to have a ‘renovation’ column status of “1” while those with negatively ranked features are more likely to have a ‘renovation’ column status of “0”. Comparing the most significant positively and negatively ranked features side by side allows the user to notice emerging patterns in how renovated properties are described compared to non-renovated properties. The renovated property descriptions use vibrant words to describe the features of the property such as “granite,” “stunning,” “gorgeous,” or “stainless”. The non-renovated property descriptions focus more on describing the characteristics of the sale itself with words such as “estate sale”, “investor”, “opportunity”, or “sold”. The top and bottom 15 term sets predicting renovation status of the Linear SVC are respectively shown in FIGS. 12A, 12B.

Step 13—Results and Evaluation Methods of the ARV Regression Models.
a. There are many regression models and parameter tuning setups that could be used to predict the ARV of properties. While not strictly a necessary step, it is advised to test and evaluate the results of several different algorithms to find an optimal model setup.
b. The data processing steps of evaluating ARV regression model performances are nearly the same as those in the implementing the ARV model. The only difference is that the data with a ‘renovation’ status of “1” is split into two sets prior to training the model in order to test the results of the model on a separate subset of data that it was trained on. Results were obtained by splitting the data into a training set and test set on an 80/20 split (other splits are acceptable). The first set of data is used to train the ARV regression model the same way it is implemented in the system. The trained model is now used to predict the ARV of the second set of data (aka. the “testing data”). The ARV results are compared with the sold prices of the renovated testing data in order to generate metrics to evaluate the predictive power of the regression model being evaluated. This process was repeated with many different algorithms and parameters to see which model setup gave the best prediction metrics. The model that produces the best prediction metrics will be the one that is used to generate the ARV values in the finished system.
c. The coefficient of determination, otherwise known as R Squared (R2), is a common metric used for evaluating performance of the ARV regression models. This metric summarizes the proportion of the variance in the dependent variable that is predicted by its independent variables. The closer the R2 score is to 1.0, the more the variance can be explained by the independent variables in the model. For more information on the construction and use of the R2 score or other evaluation metrics for regression models, see chapter 10 in Python Machine Learning: Machine Learning and Deep Learning with Python, scikit-learn, and TensorFlow by Sebastian Raschka and Vahid Mirjalili.
   i. Raschka, S., & Mirjalili, V. (2017). Python Machine Learning: Machine Learning and Deep Learning with Python, scikit-learn, and TensorFlow (Second), Packt Publishing.
d. The algorithms tested for the ARV regression model are: ExtraTreesRegression, RandomForestRegression, Gradient Boosting Regression, KNN Regression, and Linear Regression. Many other algorithms exist that could have been tested. The table below provides the evaluation metrics and run times of the regression model results. The median absolute errors are a common metric for comparing models against each other so it is shown as well.

| | | 50th Percentile of | Run Time |
|---|---|---|---|
| Regression Model | R2 Score | Absolute Errors | (seconds) |
| Extra Trees Regression | 0.942 | 5.24% | 36.1 s |
| Random Forest Regression | 0.934 | 5.34% | 58.8 s |
| Gradient Boosting Regression | 0.930 | 6.02% | 36.6 s |
| KNN Regression | 0.901 | 7.13% | 4 min 30 s |
| Linear Regression | 0.883 | 8.57% | 0.162 s |

e. The Extra Trees regression and Random Forest regression models performed especially well. In this case, the Extra Trees regression model edged out the similar Random Forest regression model with the best prediction scores and second quickest run time.

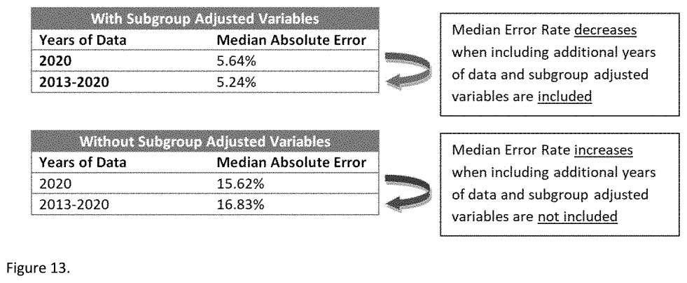

Step 14—Clarifying Importance of the Subgroup-Adjusted Variable Innovation.
a. Properties with virtually identical characteristics and similar square footage often have very large differences in sold prices simply because they are located in different neighborhoods, are of different property types, or are sold in different time periods. These large fluctuations can occur due to factors such as differences in neighborhood crime rates. It is therefore standard practice to subdivide property data into subgroups of comparable properties before doing any kind of value comparison. Similar comparables are properties that have the same type, are sold in the same time period, and are located in the same geographic region. Including data outside of the similar subgroup typically results in increased errors of any prediction algorithms. These errors fall into two categories:
   i. Errors that occur due to differences in median prices between subgroups.
   ii. Errors that occur due to comparative differences of a subject property's characteristics deviating from the median characteristics of other properties in the same subgroup.
b. It was discovered in testing that these errors can be mitigated by subdividing the property data into their subgroups and calculating subgroup median price and the subgroup-adjusted variables. While non-adjusted variables can only be interpreted in the general context of the entire data, the subgroup-adjusted variables are interpreted in the unique context of each subgroup. The subgroups of data are then recombined into a single set, but they retain the customized variables derived while they were still in their subgroups.
c. Combining the subgroup median price and the subgroup-adjusted variables with the other property variables results in a robust feature set that greatly mitigates prediction errors due to subgroup differences. Reducing these errors creates the opportunity to improve prediction models by including additional property data far beyond a typical subgroup set as comparables. This is possible because the subgroup-adjusted variables specifically account for the differences between neighborhood, time sold, and property type among different subgroups. This advancement means that the real estate industry no long has to throw out most of their data before training a prediction model. FIG. 13 shows how the inclusion of subgroup adjusted variables has resulted in improved median absolute error rates when seven years of additional data are included for the ARV regression model.

Step 15—During the Testing and Evaluation Phase, Several Surprising Sources of Improved Performance were Identified and Documented.
a. Real estate valuation models typically rely on postal zip codes or counties as the location grouping criteria. It was discovered in testing that using the rarely seen census tract variable as the geography grouping variable results in a boost in prediction accuracy for all models tested. However, obtaining the census tract for every property by feeding such a large amount of data through the census geocoder API does increase the processing time of the system.
b. When identifying comparables for a subject property, it is common practice to exclude any property that was not sold within several months of the subject property. However, it was discovered that the subgroup-adjusted variables reduce the penalization in accuracy when including sold data from across different time periods in the training data. As a result, gains in model prediction accuracy could be obtained by expanding the training data set to several years of sold property data if the subgroup-adjusted variables were included.
c. Similarly, when identifying comparables for a subject property, it is common practice to exclude any property that was not sold in the same geographic area of the subject property. However, it was discovered that the subgroup-adjusted variables reduce the penalization in accuracy when including sold data from across different geographic regions in the training data. As a result, gains in model prediction accuracy could be obtained by expanding the training data set to beyond the immediate neighborhoods of the subject property when the subgroup-adjusted variables were included.
d. An alternative method for determining property valuation was discovered by using the difference from the median sold price variable, ‘diffFrom_MedTotal_ClosePrice’, as the dependent variable for the regression model to predict (instead of ‘ClosePrice’). The estimated value of the subject property can then be calculated simply by adding the difference from the median sold price with the median sold price of the subgroup—a known value. Essentially the regression model is now only predicting the price difference that a property will sell for from its subgroup median (instead of predicting the entire price). The result is a unique valuation estimate that, in some cases, yields an increase in regression model prediction accuracy.
e. The ‘difFrom_MedTotal_Price’ and ‘diffFrom_MedTotal_TaxAssessmentPerSqft’ variables identified properties with disproportionately higher (or lower) prices than their subgroup. Strong positive values in these variables were particularly strong indicators of a recently renovated property. By contract, strong negative values in these variables were particularly strong indicators of a non-renovated (if not deteriorating) property.
f. The ngram_range parameter identifies the number of words in each phrase that the TfidfVectorizer( ) function converts into a sparse matrix for use in the renovation prediction model. While examining the renovation model prediction accuracy scores using different parameters, it was discovered that the optimal maximum size of the number of words in each phrase is 2. Setting the ngram_range to any number higher than 2 substantially increased processing time while yielding little to no increase in prediction accuracy.

It will be understood that, while various aspects of the present disclosure have been illustrated and described by way of example, the invention claimed herein is not limited thereto, but may be otherwise variously embodied within the scope of the following claims.

We claim:

1. A computer-implemented method for selecting a predictive model to predict the post-renovation value of real estate properties from real estate listings, comprising the steps of:
collecting real estate listing and sales data for a set of real estate properties grouped in comparable clusters;
identifying a set of unique tags included in the real estate listings, the set of unique tags being descriptive of property conditions;
identifying a first subset of the set of unique tags that consistently indicate properties in a first subset of real estate properties with a renovated status, and a second subset of the unique tags that consistently indicate a second subset of properties in the set of real estate properties with an un-renovated status;
training two or more mathematical models based on a remaining subset of the set of unique tags to predict a renovation status for each of the remaining properties in the set of real estate properties;
determining a performance measurement for predictions made by each of the two or more mathematical models; and
selecting one of the two or more mathematical models as the predictive model based on the performance measurements.

2. The method of claim 1, wherein the comparable clusters are census tracts.

3. The method of claim 1, wherein the performance measurement is an error rate.

4. The method of claim 1, wherein the performance measurement is a run time.
